(19) United States
(12) Patent Application Publication
(10) Pub. No.: US 2023/0049927 A1
(43) Pub. Date: Feb. 16, 2023

(54) Autonomous Drive Function Which Takes Driver Interventions into Consideration for a Motor Vehicle

(71) Applicant: ZF Friedrichshafen AG, Friedrichshafen (DE)

(72) Inventors: Valerie Engel, Markdorf (DE); Andreas Wendzel, Grünkraut (DE); Maik Dreher, Tettnang (DE)

(21) Appl. No.: 17/786,918

(22) PCT Filed: Dec. 17, 2019
(86) PCT No.: PCT/EP2019/085536

§ 371 Date: Jun. 17, 2022

(51) Int. Cl. B60W 60/00; B60W 50/10; B60W 50/00

(52) U.S. Cl. CPC B60W 60/005; B60W 50/10; B60W 50/0097; B60W 2050/0008; B60W 2050/0022; B60W 2050/0012

(57) ABSTRACT

A processor unit (3) is configured to execute an autonomous driving function of the motor vehicle (1) during a first instance such that the motor vehicle (1) travels autonomously based at least in part on the execution of the autonomous driving function. The processor unit (3) is further configured to store a driver intervention, the driver intervention being performed by a driver of the motor vehicle (1) during the first instance while the motor vehicle (1) travels autonomously based on the execution of the autonomous driving function. Additionally, the processor unit (3) is configured to execute the autonomous driving function during a second instance, subsequent to the first instance, based at least in part on the stored driver intervention such that the motor vehicle (1) travels autonomously based at least in part on the execution of the autonomous driving function according to the stored driver intervention.

### CROSS-REFERENCE TO RELATED APPLICATION

The present application is related and has right of priority and is a nationalization of PCT/EP2019/085536 filed in the European Patent Office on Dec. 17, 2019, the entirety of which is incorporated by reference for all purposes.

### FIELD OF THE INVENTION

The invention relates generally to an autonomous driving function for a motor vehicle, wherein the autonomous driving function takes one or multiple driver intervention(s) into account. In particular, a processor unit configured therefor, a method, and a computer program product are described herein. Additionally, a motor vehicle having the aforementioned processor unit is described herein.

### BACKGROUND

Autonomous driving strategies utilize surroundings data, map data, and vehicle data to determine an optimal vehicle behavior. However, improvements of an autonomous driving function of a motor vehicle with respect to preferences of a driver are needed.

### SUMMARY OF THE INVENTION

An adaptation of an autonomous driving strategy, in particular, to driver input is described herein. An autonomous driving function is adapted to driver interventions in order to make the autonomous driving function more similar to human behavior. In particular, a typical speed is stored at spots at which travel has repeatedly taken place faster than was optimized, once this has been confirmed by the driver of the motor vehicle. By utilizing a model predictive control (MPC) optimization algorithm as a driving strategy, either the marginal conditions or constraints (for example, cornering speed or speed limits) or the weighting factors of the terms of the cost function (for example, time, energy, or comfort) are modified.

Driver interventions are considered according to different criteria. On the one hand, driver intervention considerations are location-based, for example, if the driver has intervened in a route section multiple times, this pattern is stored and processed for this route section similarly to map data. In addition, other dependencies are also optionally taken into account. For instance, times of day (for example, more sporty behavior is desired in the evening than in the morning), loads (slower with a trailer than without), or the number of passengers are taken into account.

In this sense, according to a first aspect of the invention, a processor unit is provided for carrying out an autonomous driving function for a motor vehicle with regard to a driver intervention. The processor unit is configured for carrying out an autonomous driving function such that a motor vehicle travels autonomously based on the execution of the autonomous driving function. In addition, the processor unit is configured for storing a driver intervention into the autonomous driving function of the motor vehicle, wherein the driver intervention is carried out by a driver of the motor vehicle while the motor vehicle travels autonomously based on the execution of the autonomous driving function. Moreover, the processor unit is configured for subsequently carrying out the autonomous driving function with regard to the stored driver intervention.

The storage is carried out, for example, on a memory unit that is arranged within the motor vehicle. In particular, the memory unit belongs to the processor unit. The processor unit accesses the memory unit, in particular by a communication interface configured therefor. The memory unit is instead located outside the motor vehicle and communicatively connected to the processor unit.

The present invention is suited for autonomous driving functions, the levels of automation of which are below level 5 (for example, according to SAE J3016), in particular up to level 3, wherein the driver still has the opportunity to influence the driving operation. An influence of the driving function of this type represents a “driver intervention.” The driver intervention takes place, for example, via acceleration or deceleration in the form of a “match” of the autonomous driving function. The driver intervened in the automated driving function multiple times on routes that he/she has already traveled multiple times. For example, the driver slows down or decelerates the motor vehicle, for example, due to an unclear spot or due to a new speed limit. An acceleration of the motor vehicle is carried out by the driver, for example, due to an increased speed limit or due to a personal preference. The present invention enables the autonomous driving function to “learn” the interventions of the driver due to the storage and to take these into account in subsequent journeys.

The autonomous driving function is formed, at least in part, by a MPC algorithm for the model predictive control of the motor vehicle, wherein the MPC algorithm includes a longitudinal dynamics model of the motor vehicle and a cost function to be minimized. The processor unit is configured for executing the MPC algorithm such that the motor vehicle travels autonomously based on the execution of the MPC algorithm, and, after the driver intervention is carried out by the driver and stored by the processor unit, determining an input variable for the model predictive control of the motor vehicle by executing the MPC algorithm with regard to the stored driver intervention such that the cost function is minimized.

The method of model predictive control (MPC) is selected in order to find, in any situation under established marginal conditions and constraints, an optimal solution for a so-called “driving efficiency” driving function, which is to provide an efficient driving style. Methods of model predictive control (MPC) are utilized in the field of closed-loop trajectory control, for example, for closed-loop prime mover control in the context of autonomous driving. The MPC method is based on a system model that describes the behavior of the system. In addition, the MPC method is based, in particular, on an objective function or on a cost function that describes an optimization problem and determines which state variables are to be minimized. The state variables for the “driving efficiency” driving function are, in particular, the vehicle speed or the kinetic energy, the energy remaining in the battery of an electric vehicle drive system, and the driving time. Energy consumption and driving time are optimized, in particular, on the basis of the uphill grade of the upcoming route and constraints or side conditions for speed and drive force, and on the basis of the current system state. The present invention enables an adaptation of the MPC optimization such that the MPC-based autonomous driving function of the motor vehicle is becomes more similar to human behavior.

The longitudinal dynamics model of the drive train includes a vehicle model with vehicle parameters and drive train losses (in particular, approximated characteristic maps). In particular, findings regarding upcoming route topographies (for example, curves and uphill grades) are incorporated into the longitudinal dynamics model of the drive train. In addition, findings regarding speed limits on the upcoming route are also optionally incorporated into the longitudinal dynamics model of the drive train.

Current state variables are measured and appropriate data is recorded and supplied to the autonomous driving function, in particular to the MPC algorithm. In this way, route data from an electronic map is updated, in particular cyclically, for an anticipation horizon or prediction horizon (for example, 400 m) ahead of the motor vehicle. The route data includes, for example, uphill grade information, curve information, and information about speed limits. Moreover, a curve curvature is converted, via a maximum permissible lateral acceleration, into a speed limit for the motor vehicle. In addition, a position finding of the motor vehicle is carried out, in particular via a Global Navigation Satellite System (GNSS) signal for the precise localization on the electronic map.

The processor unit is configured for controlling, by a closed-loop system, an electric machine of a drive train of the motor vehicle via the MPC algorithm, wherein the MPC algorithm includes a longitudinal dynamics model of the drive train. In addition, the processor unit is configured for determining an input variable for the closed-loop control of the electric machine by executing the MPC algorithm with regard to the stored driver intervention such that the motor vehicle is driven autonomously by the electric machine and such that the cost function is minimized.

The cost function includes, as a first term, an electrical energy weighted with a first weighting factor, the electrical energy being provided within a prediction horizon by a battery of the drive train for driving the electric machine and predicted according to the longitudinal dynamics model. In addition, the cost function includes, as a second term, a driving time weighted with a second weighting factor, the driving time being the driving time that the motor vehicle needs in order to cover the entire distance predicted within the prediction horizon predicted according to the longitudinal dynamics model. The processor unit is configured for determining the input variable for the closed-loop control of the electric machine of the motor vehicle by executing the MPC algorithm with regard to the stored driver intervention and as a function of the first term and as a function of the second term such that the cost function is minimized.

The cost function has exclusively linear and quadratic terms. As a result, the overall problem has the form of a quadratic optimization with linear constraints and a convex problem results, which is solved accurately and quickly. The objective function or the cost function is formulated with a weighting (weighting factors), wherein, in particular, an energy efficiency, a driving time, and a ride comfort are calculated and weighted. An energy-optimal speed trajectory is calculated online for an upcoming horizon on the processor unit, which forms, in particular, an integral part of a central control unit of the motor vehicle. By utilizing the MPC method, the target speed of the motor vehicle is additionally cyclically recalculated based on the current driving mode and the upcoming route information.

A minimization of the driving time for the prediction horizon and a minimization of consumed energy are carried out by the cost function of the MPC algorithm. In one embodiment, a minimization of torque changes for the prediction horizon is also carried out. With respect to the input for the model predictive control, for example, speed limits, physical limits for the torque, and rotational speeds of the electric machine are supplied to the MPC algorithm as constraints. In addition, control variables for the optimization are supplied to the MPC algorithm as inputs, in particular the speed of the vehicle (which is proportional to the rotational speed), the torque of the electric machine, and the state of charge of the battery. As the output of the optimization, the MPC algorithm yields an optimal rotational speed and an optimal torque for calculated points in the anticipation horizon. With respect to the implementation of the MPC in the vehicle, a software module is connectable downstream from the MPC algorithm, which determines a currently relevant state and transmits the currently relevant state to a power electronics unit.

Energy consumption and driving time are both evaluated and weighted at the end of the horizon. These terms therefore are active only for the last point of the horizon. In this sense, the cost function in one embodiment includes an energy consumption final value—which the predicted electrical energy assumes at the end of the prediction horizon—weighted with the first weighting factor, and the cost function includes a driving time final value—which the predicted driving time assumes at the end of the prediction horizon—weighted with the second weighting factor.

In order to ensure comfortable driving, additional terms are introduced for penalizing torque surges. In this sense, the cost function includes a third term having a third weighting factor. The third term includes a value of a torque that the electric machine provides for driving the motor vehicle, which is predicted according to the longitudinal dynamics model. The processor unit is configured for determining the input variable for the electric machine by executing the MPC algorithm as a function of the first term, as a function of the second term, and as a function of the third term such that the cost function is minimized.

For the first point in the horizon, the deviation from the most recently set torque is evaluated as negative in order to ensure that there is a seamless and smooth transition during the change-over between an old trajectory and a new trajectory. In this sense, the third term includes a first value—a torque that the electric machine provides for driving the motor vehicle at a first waypoint within the prediction horizon, which is predicted according to the longitudinal dynamics model, the torque being weighted with the third weighting factor. The third term includes a zeroth value—a torque that the electric machine provides for driving the motor vehicle at a zeroth waypoint, which is situated directly ahead of the first waypoint, the torque being weighted with the third weighting factor. The zeroth torque is, in particular, a real—not merely predicted—torque provided by the electric machine. In the cost function, the zeroth value of the torque is subtracted from the first value of the torque.

Alternatively, the third term includes a first value—a drive force that the electric machine provides for driving the motor vehicle at a first waypoint within the prediction horizon, which is predicted according to the longitudinal dynamics model, the drive force being weighted with the third weighting factor. The third term includes a zeroth value—a drive force that the electric machine provides for driving the motor vehicle at a zeroth waypoint, which is situated directly ahead of the first waypoint, the drive force being weighted with the third weighting factor. In the cost function, the zeroth value of the drive force is subtracted from the first value of the drive force.

The waypoints that are taken into account by the MPC algorithm are, in particular, discrete waypoints that follow one another at a certain frequency. In this sense, the zeroth waypoint and the first waypoint represent discrete waypoints, wherein the first waypoint immediately follows the zeroth waypoint. The zeroth waypoint is situated before the prediction horizon. The zeroth torque value is measured or determined for the zeroth waypoint. The first waypoint represents, in particular, the first waypoint within the prediction horizon. The first torque value is predicted for the first waypoint. Therefore, the actually determined zeroth torque value is compared against the predicted first torque value.

Additionally, excessively high torque gradients within the horizon are disadvantageous, and so, in one embodiment, these are already penalized in the objective function. For this purpose, the quadratic deviation of the drive force per meter is weighted and minimized in the objective function. In this sense, the cost function includes a fourth term weighted by a fourth weighting factor, wherein the fourth term includes a gradient of the torque predicted according to the longitudinal dynamics model or an indicator value for a gradient of the torque predicted according to the longitudinal dynamics model. The processor unit is configured for determining the input variable for the electric machine by executing the MPC algorithm as a function of the first term, as a function of the second term, as a function of the third term, and as a function of the fourth term such that the cost function is minimized.

In one embodiment, the fourth term includes a quadratic deviation of the gradient of the torque, which has been multiplied by the fourth weighting factor and summed. In addition, the cost function includes a quadratic deviation—a drive force that the electric machine provides in order to propel the motor vehicle one meter in the longitudinal direction, summed with the fourth weighting factor. In this sense, the fourth term includes a quadratic deviation—a drive force that the electric machine provides in order to propel the motor vehicle one meter in the longitudinal direction, multiplied by the fourth weighting factor and summed.

Speed limits, established, for example, by road traffic regulations, are hard limits for the optimization, which are not to be exceeded. A slight exceedance of the speed limits is always permissible in reality and tends to be the normal case primarily during transitions from one speed zone into a second zone. In dynamic surroundings, in which speed limits shift from one computing cycle to the next computing cycle, it happens, in the case of very hard limits, that a valid solution for a speed profile is no longer found. In order to increase the stability of the computational algorithm, a so-called soft constraint is introduced into the objective function. In particular, a so-called slack variable becomes active in a predefined narrow range before the hard speed limit is reached. Solutions that are situated very close to this speed limit are evaluated as, i.e., poorer solutions, the speed trajectory of which maintains a certain distance to the hard limit. In this sense, the cost function includes, as a fifth term, a slack variable weighted with a fifth weighting factor. The processor unit is configured for determining the input variable for the electric machine by executing the MPC algorithm as a function of the first term, as a function of the second term, as a function of the third term, as a function of the fourth term, and as a function of the fifth term such that the cost function is minimized.

In order to respect the physical limits of the drive train components, the tractive force is limited via a limitation of the characteristic map of the electric machine. For example, the battery is the limiting element for the maximum recuperation. In order not to damage the battery, a certain negative power value should not be fallen below.

By utilizing an optimization algorithm as a strategy, either the marginal conditions or constraints (for example, cornering speed, speed limits, . . . ) or the weighting factors of the terms of the cost function (time, energy, comfort, torque . . . ) are modified. In this sense, the processor unit in one embodiment is configured for storing the driver intervention by modifying a constraint or a weighting factor of the cost function.

In some cases, not every driver intervention has been intentionally carried out or the driver does not want the MPC to “notice” the driver intervention, in order to adapt the optimization for the future. Therefore, the processor unit in one embodiment is configured for storing the driver intervention if the driver intervention has been confirmed by the driver. As a result, it is ensured that exclusively intentional driver interventions are utilized for the optimization. Therefore, this embodiment enables an adaptation of the driving strategy to driver input. For example, a storage of a typical speed takes place at spots at which travel has repeatedly taken place faster than was optimized, once the driver has confirmed this.

A locality at which the motor vehicle is located while the driver intervention takes place is taken into account. In one further embodiment, the driver intervention is stored as a location-based data set. For example, a route section, on which the motor vehicle was driven while the driver intervention was carried out by the driver, is stored. The locality includes a certain position, but also a route, for example, a section of a road. The locality at which the motor vehicle is located in the autonomous driving mode while the intervention by the driver takes place is ascertained by appropriate sensors of the motor vehicle, for example, via GNSS sensors. The processor unit is configured for accessing appropriate sensor data.

For example, the motor vehicle travels autonomously at a first speed. The first speed is based on the execution of the autonomous driving function, for example, on the MPC, but it does not yet take into account a driver intervention due to the locality at which the motor vehicle is located. For example, the first speed is 70 km/h. The motor vehicle travels autonomously at the first speed on a section of a road based on the execution of the autonomous driving function, for example, based on the MPC. If the first speed appears to the driver to be too high, he/she decelerates (driver intervention) the motor vehicle to a second speed, which is lower than the first speed, for example, to 60 km/h. This second speed corresponds to the speed preference of the driver of the motor vehicle on the section of the road. The speed preference or the reduction of the speed from the first speed to the second speed is stored in a location-based data set as a driver intervention. In particular when the driver has intervened multiple times during the autonomous driving operation of the motor vehicle on the section of the road, this intervention is stored and processed for this route section similarly to map data. The location-based data set includes, for example, first data, which represent the above-described locality, and second data, which represent the above-described second speed (speed preference).

When the processor unit executes the autonomous driving function in the future, for example, according to the MPC algorithm, such that the motor vehicle travels autonomously, the location-based data set is supplied to the autonomous driving function, in particular to the MPC algorithm, as input. The location-based data set is therefore taken into account as a stored driver intervention in order to determine an input variable for the closed-loop control of the autonomous driving of the motor vehicle, in particular an input variable for the electric machine of the motor vehicle, such that the cost function of the MPC is minimized. The next time the motor vehicle travels autonomously on the above-described section of the road, the speed preference of the driver on this road section is taken into account in the autonomous driving function, in particular in the MPC. In this way, the autonomous driving function, in particular the MPC, has “learned” the speed preference of the driver on the described route section.

In addition, a point in time or a period of time at which or within which the driver intervention is carried out by the driver is taken into account. For example, a time of day is taken into account, wherein, for example, the driver desires a more sporty behavior in the evening than in the morning. In this sense, in one embodiment, the driver intervention is stored as a time-based data set. The point in time or the period of time at which or within which the driver intervention is carried out by the driver is ascertained by appropriate digital time-measuring instrument(s) (for example, clocks) of the motor vehicle. The processor unit is configured for accessing appropriate time data of the digital time-measuring instrument.

For example, the motor vehicle travels autonomously at a first speed. The first speed is predefined due to the execution of the autonomous driving function and is based, for example, on the MPC, but it does not yet take into account a driver intervention due to the present time of day at which the motor vehicle travels autonomously, for example, in the evening. For example, the first speed is 70 km/h. The motor vehicle travels autonomously in the evening at the first speed, controlled, by an open-loop system, by the autonomous driving function, in particular based on the MPC. If the driver would rather drive faster or in a sportier manner, he/she accelerates (driver intervention) the motor vehicle to a second speed, which is higher than the first speed, for example, to 80 km/h. This second speed corresponds to the speed preference of the driver of the motor vehicle at the given time of day (evening in the example described). The speed preference or the increase of the speed from the first speed to the second speed is stored in a time-based data set as a driver intervention. The time-based data set includes, for example, first data, which represent the above-described time of day (for example, a period of time between 20:00 hours and 23:00 hours), and second data, which represent the above-described second speed (speed preference).

When the processor unit executes the autonomous driving function in the future, in particular, based on the MPC algorithm, in order to control an autonomous driving operation of the motor vehicle by a closed-loop system, the time-based data set is supplied to the autonomous driving function, in particular to the MPC algorithm, as input. The time-based data set is therefore taken into account as a stored driver intervention in order to determine an input variable for the closed-loop control of the autonomous driving of the motor vehicle, in particular an input variable for the electric machine of the motor vehicle, such that the cost function is minimized. The next time the motor vehicle travels autonomously in the evening, the speed preference of the driver at this time of day is taken into account in the autonomous driving function, in particular in the MPC. In this way, the autonomous driving function, in particular the MPC, has “learned” the speed preference of the driver at the described time of day.

In addition, a load that the motor vehicle transports while the driver intervention takes place is taken into account. In one further embodiment, the driver intervention is stored as a load-based data set. For example, a load weight of the motor vehicle while the driver intervention was carried out by the driver is stored. The load weight is caused by vehicle occupants, luggage, or other loads on the motor vehicle. In addition, a load hauled by the vehicle (if the motor vehicle pulling a trailer, how great is the load of the trailer?) while the driver intervention is carried out by the driver is stored. The load weight and/or the load hauled are/is ascertained by appropriate sensors of the motor vehicle. The processor unit is configured for accessing appropriate load data, which is generated by the sensors.

For example, the motor vehicle travels autonomously at a first speed. The first speed is predefined due to the execution of the autonomous driving function and is based, for example, on the MPC, but it does not yet take into account a driver intervention due to the load of the motor vehicle. For example, the first speed is 70 km/h. If, for example, the load weight of the motor vehicle is relatively high and/or the load hauled by the motor vehicle is relatively high, the first speed may appear to the driver to be too high and he/she decelerates the motor vehicle to a second speed, which is lower than the first speed, for example, to 60 km/h. This second speed corresponds to the speed preference of the driver with the given load of the motor vehicle. The speed preference or the decrease of the speed from the first speed to the second speed is stored in a load-based data set as a driver intervention. The load-based data set includes, for example, first data, which represent the above-described load of the motor vehicle, and second data, which represent the above-described second speed (speed preference).

When the processor unit executes the autonomous driving function in the future, in particular, based on the MPC algorithm, in order to control, by a closed-loop system, an autonomous driving operation of the motor vehicle, the load-based data set is supplied to the autonomous driving function, in particular to the MPC algorithm, as input. The load-based data set is therefore taken into account as a stored driver intervention in order to determine an input variable for the closed-loop control of the autonomous driving of the motor vehicle, in particular an input variable for the electric machine of the motor vehicle, such that the cost function is minimized. The next time the motor vehicle travels autonomously with the described load, the speed preference of the driver with this load is taken into account in the autonomous driving function, in particular in the MPC. In this way, the autonomous driving function, in particular the MPC, has “learned” the speed preference of the driver with the described load.

In addition, a number of vehicle occupants, in particular passengers, that the motor vehicle transports while the driver intervention takes place is taken into account. In one further embodiment, the driver intervention is stored as a vehicle occupant-based data set. For example, one further vehicle occupant, beside the driver of the motor vehicle, is located in the interior space of the motor vehicle while the driver intervention was carried out by the driver. The number of vehicle occupants is ascertained, for example, via weight sensors in the vehicle seats or by interior space cameras. The processor unit is configured for accessing appropriate sensor data.

For example, the motor vehicle travels autonomously at a first speed. The first speed is predefined by the autonomous driving function and is based on the MPC, but it does not yet take into account a driver intervention due to the load of the motor vehicle. For example, the first speed is 70 km/h. If, for example, one further vehicle occupant, beside the driver of the motor vehicle, is located in the interior space of the motor vehicle, the first speed may appear to the driver, for example, to be too high and he/she decelerates the motor vehicle to a second speed, which is lower than the first speed, for example, to 60 km/h. This second speed corresponds to the speed preference of the driver for the given number of vehicle occupants. The speed preference or the reduction of the speed from the first speed to the second speed is stored in a vehicle occupant-based data set as a driver intervention. The vehicle occupant-based data set includes, for example, first data, which represent the above-described number of vehicle occupants, and second data, which represent the above-described second speed (speed preference).

When the processor unit executes the autonomous driving function in the future, in particular, based on the MPC algorithm, in order to control, by a closed-loop system, an autonomous driving operation of the motor vehicle, the vehicle occupant-based data set is supplied to the autonomous driving function, in particular to the MPC algorithm, as input. The vehicle occupant-based data set is therefore taken into account as a stored driver intervention in order to determine an input variable for the closed-loop control of the autonomous driving of the motor vehicle, in particular an input variable for the electric machine of the motor vehicle, such that the cost function is minimized. The next time the motor vehicle travels autonomously with the described load, the speed preference of the driver with this load is taken into account in the autonomous driving function, in particular in the MPC. In this way, the autonomous driving function, in particular the MPC, has “learned” the speed preference of the driver with the described number of vehicle occupants.

According to a second aspect of the invention, a motor vehicle is provided. The motor vehicle includes a driver assistance system and a drive train with an electric machine. In addition, the drive train includes, in particular, a battery. Moreover, the drive train includes, in particular, a transmission. The driver assistance system is configured for accessing an input variable for the electric machine by a communication interface, wherein the input variable has been determined by a processor unit according to the first aspect of the invention. In addition, the driver assistance system is configured for controlling, by an open-loop system, the electric machine based on the input variable. The vehicle is, for example, a motor vehicle, such as an automobile (for example, a passenger car having a weight of less than 3.5 t), a motorcycle, a motor scooter, a moped, a bicycle, an e-bike, a bus, or a truck, for example, having a weight of over 3.5 t. The vehicle belongs, for example, to a vehicle fleet.

According to a third aspect of the invention, a method is provided for carrying out an autonomous driving function for a motor vehicle with regard to a driver intervention. The method includes the steps of:
executing an autonomous driving function such that a motor vehicle travels autonomously based on the execution of the autonomous driving function,
storing a driver intervention in the autonomous driving function of the motor vehicle,
   wherein the driver intervention is performed by a driver of the motor vehicle while the motor vehicle travels autonomously based on the execution of the autonomous driving function, and
subsequently executing the autonomous driving function with regard to the stored driver intervention.

According to a fourth aspect of the invention, a computer program product is provided for carrying out an autonomous driving function for a motor vehicle with regard to a driver intervention. The computer program product, when run on a processor unit of a motor vehicle, instructs the processor unit to execute an autonomous driving function such that the motor vehicle travels autonomously based on the execution of the autonomous driving function. In addition, the computer program product, when run on the processor unit, instructs the processor unit to store a driver intervention in the autonomous driving function of the motor vehicle, wherein the driver intervention is performed by a driver of the motor vehicle while the motor vehicle travels autonomously based on the execution of the autonomous driving function. Moreover, the computer program product, when run on the processor unit, instructs the processor unit to subsequently execute the autonomous driving function with regard to the stored driver intervention.

The aforementioned definitions and comments presented with respect to technical effects, advantages, and advantageous embodiments of the processor unit also apply similarly for the vehicle according to the second aspect of the invention, for the method according to the third aspect of the invention, and for the computer program product according to the fourth aspect of the invention.

### BRIEF DESCRIPTION OF THE DRAWINGS

Exemplary embodiments of the invention are explained in greater detail in the following with reference to the diagrammatic drawing, wherein identical or similar elements are labeled with the same reference character, wherein:

FIG. 1 illustrates a schematic of a vehicle including a drive train, which includes an electric machine and a battery; and

FIG. 2 illustrates a characteristic map of an electric machine for the vehicle according to FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

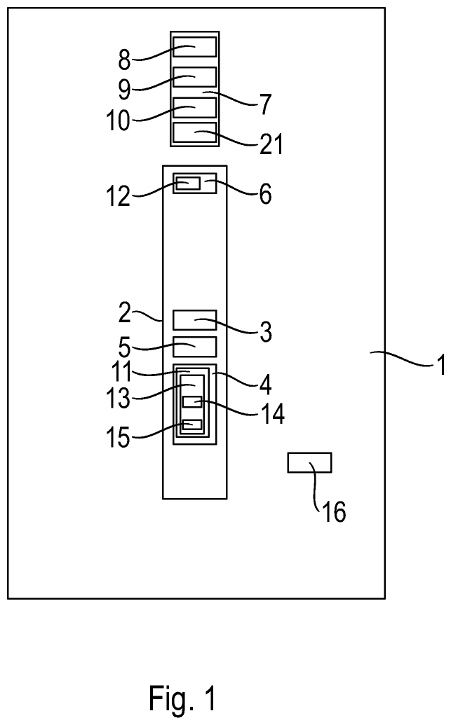

FIG. 1 illustrates a motor vehicle 1, which is, for example, a passenger car. The motor vehicle 1 includes a system 2 for carrying out or “executing” an automated driving function of the motor vehicle, for the model predictive control of the motor vehicle 1 in the exemplary embodiment shown. In particular, the system is configured for the model predictive control of an electric machine 8 of a drive train 7 of the motor vehicle 1. In the exemplary embodiment shown, the system 2 includes a processor unit 3, a memory unit 4, a communication interface 5, and a detection unit 6 for gathering state data related to the first motor vehicle 1. The drive train 7 of the motor vehicle 1 includes, for example, the electric machine 8 (operable as a motor and as a generator), a battery 9, and a transmission 10. The electric machine 8, in the motor mode, drives wheels of the motor vehicle 1 via the transmission 10, which has, for example, a constant ratio. The battery 9 provides the electrical energy necessary therefor. The battery 9 is chargeable by the electric machine 8 when the electric machine 8 is operated in the generator mode (recuperation). Optionally, the battery 9 is also chargeable at an external charging station. Likewise, the drive train of the motor vehicle 1 optionally includes an internal combustion engine 21, which, alternatively or in addition to the electric machine 8, drives the motor vehicle 1. Optionally, the internal combustion engine 21 also drives the electric machine 8 in order to charge the battery 9.

A computer program product 11 is stored on the memory unit 4. The computer program product 11 is run on the processor unit 3, for the purpose of which the processor unit 3 and the memory unit 4 are connected to each other by the communication interface 5. When the computer program product 11 is run on the processor unit 3, it instructs the processor unit 3 to perform the functions described in the following and/or to carry out or “execute” method steps.

The computer program product 11 includes an MPC algorithm 13 for executing the autonomous driving function. The MPC algorithm 13 includes a longitudinal dynamics model 14 of the drive train 7 of the motor vehicle 1 and a cost function 15 to be minimized. The processor unit 3 executes the MPC algorithm 13 and thereby predicts a behavior of the motor vehicle 1 based on the longitudinal dynamics model 14, wherein the cost function 15 is minimized. An optimal rotational speed and an optimal torque of the electric machine 8 for calculated waypoints in the anticipation horizon result as the output of the optimization by the MPC algorithm 13. For this purpose, the processor unit 3 ascertains an input variable for the electric machine 8, enabling the optimal rotational speed and the optimal torque to be reached. The processor unit 3 controls the electric machine 8 based on the ascertained input variable. In addition, this is also executable by a driver assistance system 16, however. In this way, the motor vehicle 1 travels autonomously based on the output of the executed MPC algorithm 13.

The detection unit 6 measures current state variables of the motor vehicle 1, records appropriate data, and supplies these to the MPC algorithm 13. In this way, route data from an electronic map is updated, in particular cyclically, for an anticipation horizon or prediction horizon (for example, 400 m) ahead of the motor vehicle 1. The route data includes, for example, uphill grade information, curve information, and information about speed limits. Moreover, a curve curvature is converted, via a maximum permissible lateral acceleration, into a speed limit for the motor vehicle 1. In addition, a position finding of the motor vehicle is carried out by means of the detection unit 6, in particular via a GNSS signal generated by a GNSS sensor 12 for the precise localization on the electronic map. In addition, the detection unit includes sensors for determining the load weight of the motor vehicle, for detecting the number of vehicle occupants, and a time-measuring and detection module. The processor unit 3 accesses information and/or data generated by the aforementioned sensors, for example, via the communication interface 5.

The longitudinal dynamics model 14 of the motor vehicle 1 is expressed mathematically as follows:

$$\frac{d v ( t )}{d t} = ( {F}_{trac} ( t ) - {F}_{r} ( α ( t ) ) - {F}_{gr} ( α ( t ) ) - {F}_{d} ( v ( t ) ) ) / {m}_{e q}$$

Wherein:
v is the speed of the motor vehicle;
F_{trac} is the tractive force that is exerted by the prime mover or the brakes upon the wheels of the motor vehicle;
Fᵣ is the rolling resistance, which is an effect of the deformation of the tires during rolling and depends on the load of the wheels (on the normal force between the wheel and the road) and, thus, on the inclination angle of the road;
F_{gr}is the gradient resistance, which describes the longitudinal component of gravity, which acts upon the motor vehicle during operation uphill or downhill, depending on the gradient of the roadway;
F_{d} is the drag force of the motor vehicle; and
m_{eq} is the equivalent mass of the motor vehicle; the equivalent mass includes, in particular, the inertia of the turned parts of the drive train, which are subjected to the acceleration of the motor vehicle (prime mover, transmission input shafts, wheels).

By converting time dependence into distance dependence

$$\frac{d}{d s} = \frac{d}{d t} * \frac{d t}{d s} = \frac{d}{d t} * \frac{1}{v}$$

and coordinate transformation in order to eliminate the quadratic speed term in the aerodynamic drag with eₖᵢₙ=*½m_{eq}*v(t)², the result is:

$$\frac{d {e}_{k i n}}{d s} = {F}_{trac} ( s ) - {F}_{r} ( α ( s ) ) - {F}_{gr} ( α ( s ) ) - {F}_{d} ( {e}_{k i n} ( s ) ) .$$

In order to ensure that the problem is quickly and easily solvable by the MPC algorithm 13, the dynamic equation of the longitudinal dynamics model 14 is linearized, in that the speed is expressed, via coordinate transformation, by kinetic energy deₖᵢₙ. As a result, the quadratic term for calculating the aerodynamic drag F_{d} is replaced by a linear term and, simultaneously, the longitudinal dynamics model 14 of the motor vehicle 1 is no longer described as a function of time, as usual, but rather as a function of distance. This fits well with the optimization problem since the anticipatory information of the electrical horizon is based on distance.

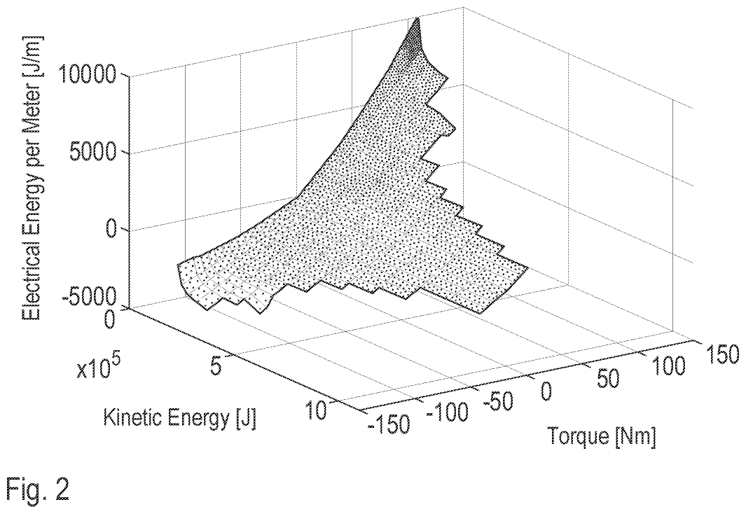

In addition to the kinetic energy, there are two further state variables, which, in the sense of a simple optimization problem, must also be described in a linear and distance-dependent manner. On the one hand, the electrical energy consumption of the drive train 7 is usually described in the form of a characteristic map as a function of torque and prime mover speed. In the exemplary embodiment shown, the motor vehicle 1 has a fixed ratio between the electric machine 8 and the road on which the motor vehicle 1 moves. As a result, the rotational speed of the electric machine 8 is directly converted into a speed of the motor vehicle 1 or even into a kinetic energy of the motor vehicle 1. In addition, the electrical power of the electric machine 8 is converted into energy consumption per meter via division by the appropriate speed. As a result, the characteristic map of the electric machine 8 obtains the form shown in FIG. 2. In order to be able to utilize this characteristic map for the optimization, it is linearly approximated:

Energy_{perMeter}≥aᵢ*eₖᵢₙ+bᵢ*F_{trac} for all i.

An exemplary cost function 15 to be minimized is expressed mathematically as follows:

$$min ( - {w}_{B a t} \cdot {E}_{B a t} ( {s}_{E} ) + {w}_{T i m e} \cdot T ( {s}_{E} ) + {w}_{T e m} \cdot {\sum }_{S = 1}^{{s}_{E} - 1} {( \frac{{F}_{A} ( s ) - {F}_{A} ( s - 1 )}{Δ s} )}^{2} + {w}_{TemStart} \cdot {( {F}_{A} ( {s}_{1} ) - {F}_{A} ( {s}_{0} ) )}^{2} + {\sum }_{S = 1}^{{s}_{E} - 1} {w}_{Slack} \cdot {Var}_{slack} )$$

Wherein:
w_{Bat} is the weighting factor for the energy consumption of the battery;
E_{Bat} is the energy consumption of the battery;
S is the distance;
S_{E-1} is the distance one time step before the end of the prediction horizon;
F_{A} is the drive force that is provided by the electric machine, transmitted by a transmission at a constant ratio, and applied at a wheel of the motor vehicle;
W_{Tem} is the weighting factor for torque gradients;
W_{Temstart} is the weighting factor for torque surges;
T is the time that the vehicle needs in order to cover the entire distance predicted within the prediction period;
w_{Time} is the weighting factor for the time T;
S_{E} is the distance to the end of the horizon;
w_{Slack} is the weighting factor for the slack variable; and
Var_{Slack} is the slack variable.

The cost function 15 has exclusively linear and quadratic terms. As a result, the overall problem has the form of a quadratic optimization with linear constraints and a convex problem results, which is solved well (e.g., accurately) and quickly.

The cost function 15 includes, as a first term, an electrical energy E_{Bat} weighted with a first weighting factor w_{Bat}, the electrical energy E_{Bat} being provided within a prediction horizon by the battery 9 of the drive train 7 for driving the electric machine 8 and predicted according to the longitudinal dynamics model.

The cost function 15 includes, as a second term, a driving time T weighted with a second weighting factor W_{Time}, the driving time T being the driving time the motor vehicle 1 needs in order to cover the predicted distance and predicted according to the longitudinal dynamics model 14. As a result, depending on the selection of the weighting factors, a low speed is not always evaluated as optimal and, thus, the problem that the resultant speed is always at the lower edge of the permitted speed no longer exists.

The energy consumption and the driving time are both evaluated and weighted at the end of the horizon. These terms are therefore active only for the last point of the horizon.

Excessively high torque gradients within the horizon are disadvantageous. Therefore, torque gradients are already penalized in the cost function 15, namely by the term

$${w}_{T e m} \cdot {\sum }_{s = 1}^{{s}_{E} - 1} {( \frac{{F}_{A} ( s ) - {F}_{A} ( s - 1 )}{Δ s} )}^{2} .$$

The quadratic deviation of the drive force per meter is weighted with a weighting factor W_{Tem} and minimized in the cost function. Alternatively to the drive force F_{A} per meter, the torque M_{EM} provided by the electric machine 8 is utilized and weighted with the weighting factor W_{Tem}, and so the alternative term

$${w}_{T e m} \cdot {\sum }_{s = 1}^{{s}_{E} - 1} {( \frac{{M}_{E M} ( s ) - {M}_{E M} ( s - 1 )}{Δ s} )}^{2}$$

results. Due to the constant ratio of the transmission 10, the drive force and the torque are directly proportional to one another.

In order to ensure comfortable driving, one further term is introduced in the cost function 15 for penalizing torque surges, namely w_{TemStart}·(F_{A}(s₁)−F_{A}(s₀))². Alternatively to the drive force F_{A}, the torque M_{EM} provided by the electric machine 8 is utilized here, and so the alternative term w_{TemStart}·(M_{EM}(s₁)−M_{EM}(S₀))² results. For the first point in the prediction horizon, the deviation from the most recently set torque is evaluated as negative and weighted with a weighting factor W_{TemStart} in order to ensure that there is a seamless and smooth transition during the change-over between an old trajectory and a new trajectory.

Speed limits are hard limits for the optimization that are not permitted to be exceeded. A slight exceedance of the speed limits is always permissible in reality and tends to be the normal case primarily during transitions from one speed zone into a second zone. In dynamic surroundings, where speed limits shift from one computing cycle to the next computing cycle, it happens, in the case of very hard limits, that a valid solution for a speed profile is no longer found. In order to increase the stability of the computational algorithm, a soft constraint is introduced into the cost function 15. A slack variable Var_{slack} weighted with a weighting factor W_{slack} becomes active in a predefined narrow range before the hard speed limit is reached. Solutions that are situated very close to this speed limit are evaluated as, i.e., poorer solutions, the speed trajectory of which maintains a certain distance to the hard limit.

The closed-loop control of the electric machine 8 of the motor vehicle 1 by the MPC algorithm 1 is suited for levels of automation below level 5 (for example, according to SAE J3016), in particular up to level 3, wherein a driver of the motor vehicle 1 still has the opportunity to influence the driving operation and/or intervene into the above-described MPC-based autonomous driving function of the motor vehicle 1. An influence of the driving operation of this type represents a “driver intervention.” The driver intervention takes place, for example, via acceleration or deceleration in the form of a “match” of the autonomous driving function. The driver may have intervened into the automated driving function multiple times on routes that he/she has already traveled multiple times. For example, the driver slows down or decelerates the motor vehicle 1, for example, due to an unclear spot or due to a new speed limit. An acceleration of the motor vehicle 1 is also carried out by the driver, for example, due to an increased speed limit or due to a personal preference.

The processor unit 3 is configured for allowing the MPC algorithm 13 to learn the interventions of the driver and to take these into account in subsequent driving operations. In particular, an adaptation of the optimization is enabled such that the MPC-based autonomous driving function of the motor vehicle 1 is moved closer to human behavior.

Thus, the driver interventions are stored, for example, on the memory unit 4 and taken into account in subsequent executions of the MPC algorithm 13 by modifying the marginal conditions and/or constraints (cornering speed, speed limits, . . . ) or the weighting factors of the cost function (time, energy, comfort, . . . ). The driver him/herself is in control of deciding which driver interventions are to be stored and utilized for the future optimization and which driver interventions are not to be stored. In order to enable this, the processor unit 3 stores the driver intervention only for the case in which the driver intervention has been confirmed by the driver, for example, by a confirmation device configured therefor, which is actuatable by the driver. As a result, it is ensured that exclusively intentional driver interventions are utilized for the optimization. Therefore, this embodiment enables an adaptation of the driving strategy to driver input. In particular, a storage of a typical speed takes place at spots at which travel has repeatedly taken place faster than was optimized, once the driver has confirmed this.

In one example, a route section, a time of day, a load weight, and a number of passengers of the motor vehicle 1 are ascertained by appropriate sensors of the detection unit 6 while the driver intervenes into the MPC-based autonomous driving function of the motor vehicle 1.

For example, the motor vehicle travels autonomously at a first speed. The first speed is based on the MPC, but it does not yet take into account the route section, the time of day, the load weight, and the number of passengers of the motor vehicle 1. For example, the first speed is 70 km/h. The motor vehicle travels autonomously at the first speed on a section of a road (route section) based on the MPC.

Based on the knowledge of the route section, the time of day, the load weight, and the number of passengers of the motor vehicle 1, for example, the first speed may appear to the driver to be too high. In order to change this, the driver decelerates (driver intervention) the motor vehicle to a second speed, which is lower than the first speed, for example, to 60 km/h. This second speed corresponds to the speed preference of the driver of the motor vehicle 1 on the present route section at the present time of day, with the present load weight, and with the present number of passengers of the motor vehicle 1. The speed preference or the reduction of the speed from the first speed to the second speed is stored as a driver intervention in a preference data set. The preference data set includes, for example, first data, which represent the route section, the time of day, the load weight, and the number of passengers, and second data, which represents the above-described second speed (speed preference).

When the processor unit 3 carries out the MPC algorithm 13 in the future in order to control, by a closed-loop system, an autonomous driving operation of the motor vehicle 1, the preference data set is supplied to the MPC algorithm 13 as input. The preference data set is therefore taken into account as a stored driver intervention in order to determine an input variable for the closed-loop control of the autonomous driving of the motor vehicle 1, in particular an input variable for the electric machine 8 of the motor vehicle 1, such that the cost function is minimized. The next time the motor vehicle 1 travels autonomously under identical or similar conditions (time of day, load weight, number of passengers) on the above-described section of the road, the speed preference of the driver on this road section is taken into account in the MPC. In this way, the MPC, has “learned” the speed preference of the driver on the described route section.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 vehicle

2 system

3 processor unit

4 memory unit

5 communication interface

6 detection unit

7 drive train

8 electric machine

9 battery

10 transmission

11 computer program product

12 GNSS sensor

13 MPC algorithm

14 longitudinal dynamics model

15 cost function

16 driver assistance system

17 first delimiting line

18 second delimiting line

19 first graph

20 second graph

21 internal combustion engine

1-13. canceled

14. A processor unit (3) for executing an autonomous driving function for a motor vehicle (1) with regard to a driver intervention, wherein the processor unit (3) is configured to:
execute an autonomous driving function of the motor vehicle (1) during a first instance such that the motor vehicle (1) travels autonomously based at least in part on the execution of the autonomous driving function;
store a driver intervention, the driver intervention being performed by a driver of the motor vehicle (1) during the first instance while the motor vehicle (1) travels autonomously based on the execution of the autonomous driving function; and
execute the autonomous driving function during a second instance, subsequent to the first instance, based at least in part on the stored driver intervention such that the motor vehicle (1) travels autonomously based at least in part on the execution of the autonomous driving function according to the stored driver intervention.

15. The processor unit (3) of claim 14, wherein:
the autonomous driving function is a model predictive control (MPC) algorithm (13) for model predictive control of the motor vehicle (1), the MPC algorithm (13) including a longitudinal dynamics model (14) of the motor vehicle (1) and a cost function (15) to be minimized,
the processor unit (3) is configured to execute the autonomous driving function of the motor vehicle (1) during the first instance by executing the MPC algorithm (13) such that the motor vehicle (1) travels autonomously based on the execution of the MPC algorithm (13), and
the processor unit (3) is configured to execute the autonomous driving function of the motor vehicle (1) during the second instance by executing the MPC algorithm (13) based at least in part on the stored driver intervention such that the cost function is minimized and an input variable for the model predictive control of the motor vehicle (1) is determined.

16. The processor unit (3) of claim 15, wherein:
the processor unit (3) is configured for controlling, by closed-loop control, an electric machine (8) of a drive train (7) of the motor vehicle (1) by the input variable such that the motor vehicle (1) is driven autonomously by the electric machine (8), the longitudinal dynamics model (14) of the motor vehicle (1) being a longitudinal dynamics model (14) of the drive train (7).

17. The processor unit (3) of claim 16, wherein:
the cost function (15) includes a first term, the first term being an electrical energy weighted with a first weighting factor, the electrical energy being provided within a prediction horizon by a battery (9) of the drive train (7) for driving the electric machine (8), the electrical energy being predicted according to the longitudinal dynamics model (14),
the cost function (15) includes a second term, the second term being a driving time weighted with a second weighting factor, the driving time being driving time the motor vehicle (1) needs to drive an entire distance predicted within the prediction horizon, the driving time being predicted according to the longitudinal dynamics model (14), and
the processor unit (3) is configured to execute the autonomous driving function of a motor vehicle (1) during the second instance by executing the MPC algorithm (13) based at least in part on the stored driver intervention, the first term, and the second term.

18. The processor unit (3) of claim 15, wherein the processor unit (3) is configured to store the driver intervention by modifying a constraint or a weighting factor of the cost function.

19. The processor unit (3) of claim 14, wherein the processor unit (3) is configured to store the driver intervention in response to the driver confirming the driver intervention.

20. The processor unit (3) of claim 14, wherein the processor unit (3) is configured to store the driver intervention as a location-based data set.

21. The processor unit (3) of claim 14, wherein the processor unit (3) is configured to store the driver intervention as a time-based data set.

22. The processor unit (3) of claim 14, wherein the processor unit (3) is configured to store the driver intervention as a load-based data set.

23. The processor unit (3) of claim 14, wherein the processor unit (3) is configured to store the driver intervention as a vehicle occupant-based data set.

24. A motor vehicle (3) including a driver assistance system (16) and a drive train (7) with an electric machine (8), wherein the driver assistance system (16) is configured to:
access, by a communication interface, the input variable determined by the processor unit (3) of claim 15; and
control, by an open-loop system, the electric machine (8) based on the input variable.

25. A method for carrying out an autonomous driving function for a motor vehicle (1) with regard to a driver intervention, the method comprising:
executing an autonomous driving function of the motor vehicle (1) during a first instance such that the motor vehicle (1) travels autonomously based at least in part on the execution of the autonomous driving function;
storing a driver intervention, the driver intervention being performed by a driver of the motor vehicle (1) during the first instance while the motor vehicle (1) travels autonomously based on the execution of the autonomous driving function; and
executing the autonomous driving function of the motor vehicle (1) during a second instance, subsequent to the first instance, based at least in part on the stored driver intervention such that the motor vehicle (1) travels autonomously based at least in part on the execution of the autonomous driving function according to the stored driver intervention.

26. A computer program product (11) for carrying out an autonomous driving function for a motor vehicle (1) with regard to a driver intervention, wherein the computer program product (11), when run on a processor unit (3) of a motor vehicle (1), instructs the processor unit (3) to:
execute an autonomous driving function of the motor vehicle (1) during a first instance such that the motor vehicle (1) travels autonomously based at least in part on the execution of the autonomous driving function;
store a driver intervention, the driver intervention being performed by a driver of the motor vehicle (1) during the first instance while the motor vehicle (1) travels autonomously based on the execution of the autonomous driving function; and
execute the autonomous driving function during a second instance, subsequent to the first instance, based at least in part on the stored driver intervention such that the motor vehicle (1) travels autonomously based at least in part on the execution of the autonomous driving function according to the stored driver intervention.
